(19) United States
(12) Patent Application Publication
(10) Pub. No.: US 2017/0262478 A1
(43) Pub. Date: Sep. 14, 2017

(54) METHOD AND APPARATUS FOR IMAGE RETRIEVAL WITH FEATURE LEARNING

(71) Applicant: THOMSON LICENSING, Issy-les-Moulineaux (FR)

(72) Inventors: Joaquin ZEPEDA SALVATIERRA, CESSON-SEVIGNE (FR); Patrick PEREZ, CESSON-SEVIGNE (FR); Aakanksha RANA, BIOT (FR)

(21) Appl. No.: 15/509,599

(22) PCT Filed: Aug. 25, 2015
(86) PCT No.: PCT/EP2015/069398

§ 371 Date: Mar. 8, 2017

(30) Foreign Application Priority Data
Sep. 9, 2014 (EP) 14306387.3

(51) Int. Cl. G06F 17/30; G06N 99/00

(52) U.S. Cl. CPC G06F 17/30271; G06F 17/3053; G06F 17/30256; G06N 99/005

(57) ABSTRACT

A method for retrieving at least one search image matching a query image commences by first extracting a set of search images. The query image is encoded into a query image feature vector and the search images are encoded into search image feature vectors using an optimized encoding process that makes use of learned encoding parameters. The Euclidean distances between the query image feature vector and the search image feature vectors are then computed. The search images are ranked based on the computed distances; and at least one highest-ranked search image is retrieved.

### TECHNICAL FIELD

This disclosure relates to retrieving images related to a search image.

### BACKGROUND ART

Image search methods generally exist in two categories, semantic search and image retrieval. In the first category, semantic search seeks to retrieve images containing visual concepts embodied in a search word or string. For example, the user might want to find images containing cats. In the second category, image retrieval seeks to find all images of the same scene even when the images have undergone some task-related transformation relative to a search or query image. Examples of simple transformations include changes in scene illumination, image cropping or scaling. More challenging transformations include wide changes in the perspective of the camera, high compression ratios, or picture-of-video-screen artifacts.

Common to both semantic search and image retrieval methods is the need to encode the image into a single, fixed-dimensional feature vector. There currently exist many successful image feature encoders and these generally operate on fixed-dimensional local descriptor vectors extracted from densely or sparsely sampled local regions of the search image. The feature encoder aggregates these local descriptors to produce a higher-dimension image feature vector. Examples of such feature encoders include the Bag-of-Words encoder, the Fisher encoder and the VLAD encoder. All these encoder perform common parametric post-processing steps that apply element-wise power computation and subsequent ι2 normalization. These encoders also depend on specific models of the data distribution in the local descriptor space. The Bag-of-Words and VLAD encoders use a model having a code book obtained using K-means, while the Fisher encoder uses a Gaussian Mixture Model (GMM). In both cases, the model defining the encoder uses an optimization objective unrelated to the image search task.

In the case of semantic search, recent work has focused on learning the feature encoder parameters to make the encoder better suited for its intended purpose. A natural learning objective that finds applicability in this situation is the max-margin objective otherwise used to learn support vector machines. Past efforts have enabled learning of the components of the GMM used in the Fisher encoder by optimizing, relative to the GMM mean and variance parameters, the same objective that produces a linear classifier commonly used to carry out the semantic search. Past approaches based on deep Convolutional Neural Networks (CNNs) can also be interpreted as feature learning methods, and these now define the new state-of-the art baseline in semantic search. Indeed, the Fisher encoder can be interpreted as a deep network, since both consist of alternating layers of linear and non-linear operations.

For the image retrieval task, however, there have been few efforts to apply feature learning. One existing proxy approach uses the max-margin objective thus yielding feature encoders that learn for semantic searching. Although the search tasks are not the same for sematic searching as compared to image retrieval, the max-margin objective approach yields improved image retrieval results, since both semantic search and image retrieval are based on human visual interpretations of similarity. Another approach to apply a learning objective to image retrieval focuses on learning the local descriptor vectors at the input of the feature encoder. The optimization objective used in this case is engineered to enforce matching of small image blocks centered on the same point in 3-D space based on the learned local descriptors but from images taken from different perspectives. One reason why these two approaches circumvent the actual task of image retrieval is the lack of any objective functions that are good surrogates for the mean Average Precision (mAP) measure commonly used to evaluate image retrieval systems. Surrogate objectives are necessary because the mAP measure is non-differentiable as it depends on a ranking of the searched images.

Thus, a need exists for an image retrieval that has a learning function that overcomes the aforementioned disadvantages.

### BRIEF SUMMARY OF THE INVENTION

Briefly, in accordance with an aspect of the present principles, a method for retrieving at least one search image matching a query image includes extracting a set of search images. Thereafter, the query images is encoded into a query image feature vector and the search images are encoded into search image feature vectors, both using an optimized encoding process that makes use of learned encoding parameters. The distances between the query image feature vector and the search image feature vectors are computed and the search images are ranked based on the computed distances. At least one highest-ranked search image is retrieved based on the ranking.

It is an object of the present principles to provide image retrieval with feature learning.

It is another object of the present principles to provide image retrieval with feature learning using a learning objective not dependent on image ranking.

It is another object of the present principles to provide image retrieval with feature learning using a learning objective minimized using a gradient-based optimization strategy resulting in application of the resulting objective to select power-normalization parameters of the encoder to improve image retrieval.

Further, it is another objective of the present principles to provide image retrieval with feature learning using a learning objective that makes use of an offset term in connection with per-cell rotation when aggregating local descriptors to yield the feature vector for the query image.

### BRIEF SUMMARY OF THE DRAWINGS

FIG. 1 depicts a block schematic diagram of a system for performing image retrieval in accordance with the present principles;

FIG. 2 depicts a portion of the system of FIG. 1 indicating the interaction between elements of the system to accomplish learning during image retrieval;

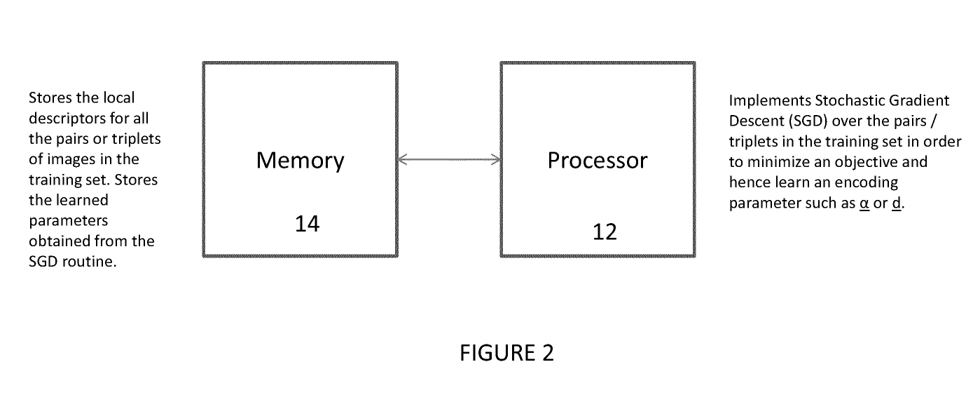

FIG. 3 depicts a plot of h_{c},(x) for various values of a;

FIG. 4 depicts a plot of the parameters c and b,;

FIG. 5 depicts in flow chart form the steps of a generalized Stochastic Gradient Descent algorithm;

FIG. 6 depicts a full image-to-feature pipeline for the image retrieval with feature learning technique of the present principles;

FIG. 7 depicts a portion of portion of the full image-to-feature pipeline of FIG. 3 showing the addition of an offset term added to each cell rotation;

FIG. 8 depicts in flow chart form the steps of a method for practicing the image retrieval with a leaning objective in accordance with the present principles;

FIG. 9 depicts images in the given data set with improved and unimproved results;

FIG. 10 depicts images of the dataset of FIG. 7 with the top five improved and unimproved results;

FIG. 11 depicts a plot of maP versus d where dₖ^{∀k} is set to d1;

FIG. 12 depicts a plot of the learning objective versus d where dₖ^{∀k} is set to d1;

FIG. 13 depicts a distribution of the parameters as after a learning procedure that uses αⱼ=0.2∀j as an initializer;

FIG. 14 depicts a set of convergence passes over a given dataset using a dense extractor with SGD following bᵢ^{opt} and bᵢ₍ₘₑₐₙ₎; and

FIG. 15 depicts a set of convergence passes over a given dataset using a Hessian affine extractor with SGD following bᵢ^{opt} and bᵢ₍ₘₑₐₙ₎;

### DETAILED DESCRIPTION

In accordance with an aspect of the present principles, an image retrieval method and apparatus makes use of a learning objective that serves as a good surrogate for mean Average Precision (mAP) measure to improve the quality of the image retrieval. Before proceeding to describe the image search technique of the present principles, the following discussion on notation will prove useful.
Notation: We denote sc\check{a}lars, vectors and matrices using, respectively standard, underlined, and double underlined typeface (e.g., scalar a, vector a and matrix A). We use vₖ to denote a vector from a sequence v₁, v₂, . . . , v_{N}, and vₖ to denote the k-th coefficient of vector v. We let [aₖ]ₖ (respectively, [aₖ]ₖ) denotes concatenation of the vectors aₖ (scalars aₖ) to form a single column vector. Finally, we use

$$\frac{\partial y}{\partial x}$$

to denote the Jacobian matrix with (i,j)-th entry

$$\frac{\partial {y}_{i}}{\partial {x}_{j}} .$$

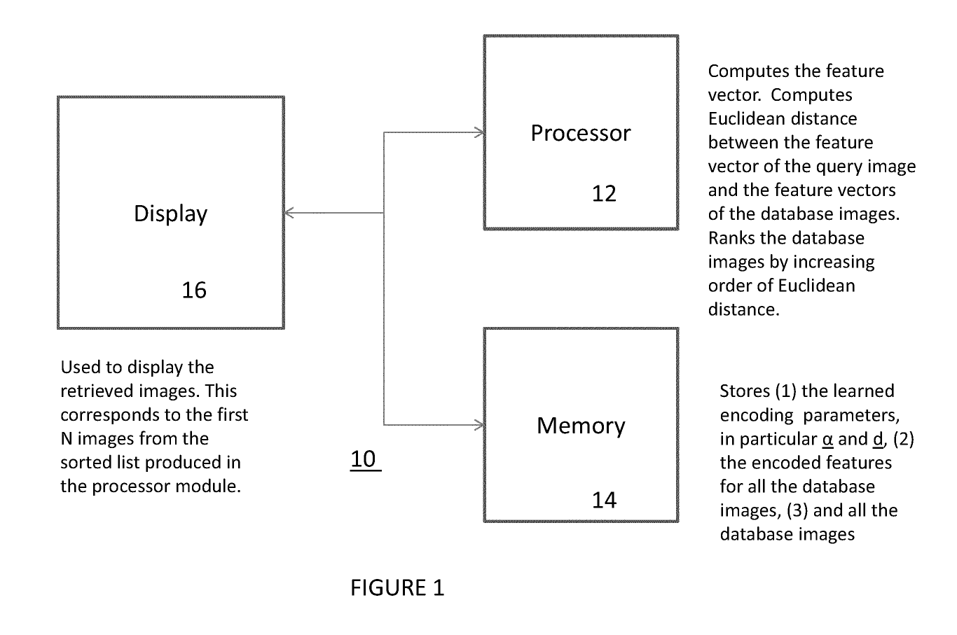

FIG. 1 depicts a block schematic diagram of a system 10 for accomplishing image retrieval with feature learning of encoder parameters in accordance with the present principles. The system 10 includes a processor 12, a memory 14, and a display 16. Although not shown, the system 10 also typically includes power supplies, interconnecting cables, various input/output devices, such as a mouse and keyboard, as well as a network interface card or the like for connecting the processor to a network such as, but not limited to, the Internet.

As described in detail hereinafter, the processor 12 performs various features associated with the image retrieval with object learning in accordance with the present principles. First upon receipt of a query image for querying a database of images (i.e., “searched images”) to retrieve image therefrom constituting a match with the query image, the processor 12 will first compute a feature vector for the query image. In this context, the processor 12 acts as an encoder to encode the query image to yield an image feature vector using one of encoding techniques described above. Thereafter, the processor 12 will compute a distance, typically, the Euclidean distance, between the feature vector associated with query image and a feature vector for each search image in a database of search images (not shown). The searched images in the database may already exist in encoded form or require encoding in the same manner as the query image in which case the processor 12 will perform encoding prior to computing the distance. The processor 12 will sort (e.g., rank) the searched images in the database based on the computed distance

The memory 14 stores both program instructions for the processor 12. Further, the memory stores data supplied to, as well as data generated by the processor 12. In this regard, the memory 14 stores: (1) learned encoding parameters, in particular a and d, associated with the encoding of the query image by the processor 12, (2) the encoded feature vectors for all the searched images, as well as (3) the searched images themselves.

The processor 12 and the memory 14 also interact with each other during learning of the encoding parameters. As described in detail hereinafter, the processor 12 establishes a learning objective, i.e., a measure of the quality of the search. The processor 12 thereafter seeks to minimize that learning objective over pairs or triplets in a training set of images, typically by implementing a gradient-based optimization strategy, such as, but not limited to,

Stochastic Gradient Descent (SGD), over the pairs/ triplets in the training set, in order to learn the optimized encoding parameters in particular α and d. Rather than make use of Stochastic Gradient Descent, other optimization techniques could be used, such as gradient descent, newton descent, conjugate gradient methods, Levenberg-Marquardt minimization, BFGS, and hybrid mixes. The memory 14 stores the local descriptors for all the pairs or triplets of the images in the training set. Further, the memory 14 stores the optimized learned parameters obtained from the gradient-based optimization.

To understand the manner in which the processor 12 computes feature vectors by encoding, the following discussion will prove helpful. Image encoders operate on the local descriptors x ∈ R^{d} extracted from each image. Hence, for purposes of discussion, images are represented as a set I={xₖ ∈ R^{d}}ₖ of local SIFT descriptors extracted densely or with the Hessian Affine region detector The Bag-of-Words encoder (BOW) constitutes one of the earliest image encoding methods and relies on a code book {cₖ ∈ R^{d}}^{L}_{K=1} obtained by applying K-means to all the local descriptors ∪ₜIt of a set of training images. Letting Ck denote the Voronoi cell {x|x∈ R^{d},k=argminⱼ|x-cⱼ|} associated to code-word cₖ, the resulting feature vector for image I is

$${r}^{b} = {[ \# ( Ck ⋂ I ) ]}_{k} , \qquad ( 1 )$$

where # yields the number of elements in the set.

The Fisher encoder relies on a GMM model also trained on ∪ₜ It. Letting βi,c_{i,}^{Σ}^{ᵢ} denote, respectively, the i-th GMM component's i) prior weight, ii) mean vector, and iii) covariance matrix (assumed diagonal), the first-order Fisher feature vector is

$${\underline{r}}^{F} = {[ \frac{p ( k \vert \underline{x} )}{\sqrt{{β}_{i}}} {{Σ}_{\underline{\_}}}_{k}^{- 1} ( \underline{x} - {\underline{c}}_{k} ) ]}_{k} . \qquad ( 2 )$$

A hybrid combination between BOF and Fisher encoders called the VLAD encoder has been proposed that offers a good compromise between the performance of the Fisher encoder and the encoding complexity of the BOF encoder. Similar to the state-of-the art Fisher encoder, the VLAD encoder encodes residuals x-cₖ, but it hard-assigns each local descriptor to a single cell Ck instead of using a costly soft-max assignment as in equation (2) for the Fisher encoder. There has been a suggestion to incorporate several conditioning steps in the VLAD encoder to improve performance of the feature encoding. The following equations define VLAD encoding:

$$\begin{matrix}{\underline{r}}_{k} = {\sum }_{\underline{x} ∈ I ⋂ {C}_{k}} \frac{\underline{x} - {\underline{c}}_{k}}{\vert \underline{x} - {\underline{c}}_{k} \vert} ∈ {ℝ}^{d} , & ( 3 ) \\ {\underline{q}}_{k} = {{Φ}_{\underline{\_}}}_{k} {\underline{r}}_{k} + {\underline{d}}_{k} , & ( 4 ) \\ {\underline{p}}^{′} = {[ {\underline{q}}_{k} ]}_{k} ∈ {ℝ}^{dL} , & ( 5 ) \\ \underline{p} = {[ {h}_{{α}_{j}} ( {p}_{j}^{′} ) ]}_{j} , & ( 6 ) \\ \underline{n} = \underline{g} ( \underline{p} ) . & ( 7 )\end{matrix}$$

Here, the scalar function h_{α}(x) and the vector function n(v) carry out power normalization and l-2 normalization, respectively:

$$\begin{matrix}h ( x ) = sign ( x ) {\vert x \vert}^{α} & ( 8 ) \\ \underline{g} ( \underline{x} ) = \frac{\underline{x}}{{\vert \underline{x} \vert}_{2}} & ( 9 )\end{matrix}$$

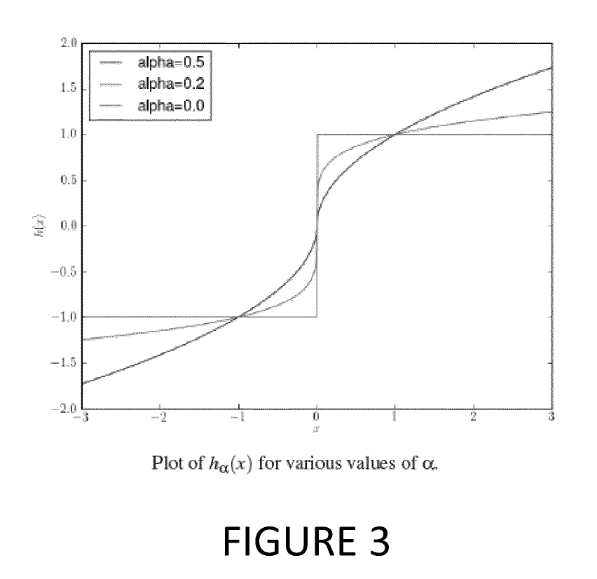

The power normalization function defined in equation (8) is widely used as a post-processing stage for image features. This power normalization function serves to mitigate (respectively, enhance) the contribution of the larger (smaller) coefficients in the vector as illustrated in FIG. 3. Combining power normalization with the orthogonal rotation matrices Φ_{kS} (obtained by PCA on the training descriptors Cₖ^{∩̅∪}ₜIₜ in the Voronoi cell) has been shown in the art to work well.

In all the approaches using power normalization, the αj are kept constant for all entries in the vector, αj =α,∀j. This restriction comes from the fact that α is chosen empirically (often to α=0.5 or α=0.2), and choosing different values for each αj is hence difficult. As described hereinafter, applying the feature learning method of the present principles to the optimization of the αj can overcome this difficulty.

Experimentally, dense local descriptor sampling, (previously shown to outperform sparsely sampled blocks but for αj=0.2), with αj=0 yields very competitive performance, with the added advantage that the resulting descriptor is binary as shown in FIG. 3. It is for this reason that an affine mapping is used in equation (4) instead of the previously used linear mapping Φrₖ. The vector dₖ allows moving the binarization threshold to non-zero values.

Feature learning has been pursued in the context of image classification or for learning local descriptors akin to parametric variants of the SIFT descriptor. However, as discussed previously, few have pursued learning features specifically for the image retrieval task. As described below, an exemplary approach to feature learning in accordance with the present principles applies optimization of the parameters of VLAD feature encoding.

The main difficulty in learning for the image retrieval task lies in the non-smoothness and non-differentiability of the standard performance measures to assess the quality of image retrieval, such the mAP parameter discussed previously. Present-day image retrieval quality assessment measures all depend on recall and precision computed over a ground-truth dataset containing known groups of matching images. A given query image serves as the starting point to obtain a ranking (ik ∈{1, . . . , N})k of the N images in a dataset of searched images (for example, by an ascending sort of the feature distances of such images relative to the query feature). Given the ground-truth matches M={ikⱼ}j for the query, the recall and precision at rank k are computed using the first k ranked images Fk={i1, . . . , ik} as follows (where # denotes set cardinality):

$$\begin{matrix}r ( k ) = \frac{\# ( {ℱ}_{k} ⋂ )}{\# } , & ( 10 ) \\ p ( k ) = \frac{\# ( {ℱ}_{k} ⋂ )}{k} . & ( 11 )\end{matrix}$$

The average precision is then the area under the curve obtained by plotting p(k) versus r(k) for a single query image. A common performance measure is the mean, over all images in the dataset, of the average precision. This mean Average Precision (mAP) measure, and all measures based on recall and precision, are non-differentiable and difficult to use in an optimization framework. The image retrieval with feature learning technique of the present principles makes use of a surrogate objective function

To understand the surrogate objective of the present principles, assume receipt of a training set consisting of images labeled i=1, . . . , N. For each image i, also assume the labels Mi ⊂{1, . . . , N} of the images that are a match to image i. Further, assume that some feature encoding scheme has been chosen and parametrized by a vector θ that yields feature vectors nᵢ(θ). The aim is to define a procedure to select good values for the parameters θ.

Consider the feature n^{j} of a given query image. Since feature vectors are often normalized (|n^{j}|2=1), the retrieval process consists of sorting the N images in descending order of n.
²Using the Euclitkan distan is equivalent, since |n′−nᵢ|²=|n′|²+|nᵢ|²−2nᵢ^{T}n′=1+1−2n′ᵢₙ^{T}.

Let Hi ⊂{1, . . . , N} clenote the union of a) the labels of the top-ranked images (except i) and b) the labels Mi of the true matches. Letting yi j=1 if j ∈ Mij and −1 otherwise, we propose the following learning objective:

$$\frac{1}{M} {\sum }_{i} {min}_{{b}_{i} ∈ ℝ} {\sum }_{j ∈ {ℋ}_{i}} φ ( {\underline{n}}_{i} , {\underline{n}}_{j} , {y}_{ij} , {b}_{i} ) , \qquad ( 12 )$$

where M is the total number of terms in the double summation. Inspired by max-margin formulations, we use the hinge penalty

φ(n, m, y,b)=max (0,ε−y·(n^{T}m−b)), (13)

noting that

$$\frac{\partial φ}{\partial \underline{n}} = \frac{\partial φ}{\partial \underline{m}} .$$

The parameters ε and bᵢ in φ (nᵢ, nⱼ, yᵢⱼ, bᵢ) promote higher scores nᵢ^{T}nj for positive pairs {i, j|j∈ [symbol] ᵢ} than for negative pairs {i, j|j ∈ [symbol] ᵢ/ [symbol] ᵢ}.

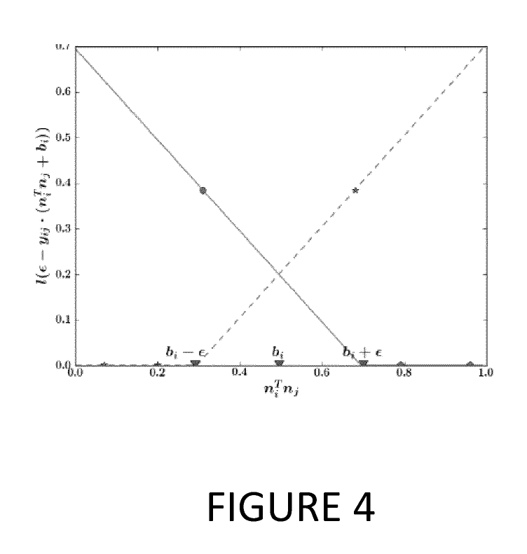

In FIG. 4, the influence of these parameters is illustrated. Parameter c promotes a margin between scores for positive and negative pairs. Since n^{T} ᵢnj ∈[−1,1], we choose ε empirically to be a small positive value.

Parameter bi shifts the penalty so that it “separates” positive scores from negative scores. Given the piece-wise linear nature of the hinge loss, the value of bi minimizing the above expression is found at one of the vertices {max[0,ε−yi j(βij-βik)]|k=1, . . . , j} where βij=(n^{T} ᵢnⱼ−yi^{ε}). Thus, it suffices to compute the inner summation at all these candidate values for bi and choose the best one.

In practice setting bi heuristically to either a) the average of the positive scores or b) the minimum positive score also worked well, simplifying the objective to

$$\frac{1}{M} {\sum }_{i} {\sum }_{j ∈ {ℋ}_{i}} φ ( {\underline{n}}_{i} , {\underline{n}}_{j} , {y}_{ij} , {b}_{i} ) . \qquad ( 14 )$$

FIG. 4 depicts a plot of the parameters c and bi in equation (14) used to calibrate the hinge penalty to the scores n^{T}ᵢnⱼ. We use x markers for negative scores nᵢ^{T}nⱼ where j ∉ [symbol] ᵢ and o markers for positive scores where j ∈ [symbol] ᵢ.

As mentioned previously, the formulation in equation (14) is similar to max-margin formulations used to learn linear SVM classifiers w. Feature learning approaches exist that use this same SVM objective to learn the encoder parameters θ for classification. Note that this is very different from the approach of the present principles since, in image retrieval, the retrieval scores are given by similarities between the features themselves, as exemplified by the n^{T}ᵢnⱼ components in the objective set forth in equation (14). Classification scores are instead given by similarities between the learned classifier vector w and the features nᵢ.

Stochastic Gradient Descent (SGD) is a well-established, robust optimization method offering advantages when computational time or memory space is the bottleneck. The image retrieval with feature learning technique of the present principles uses SGD to optimize the learning objective set forth in equation (14). Given the parameter estimate θₜ at iteration t, SGD substitutes the gradient for the objective as follows:

$${{\frac{\partial f}{\partial \underline{θ}} \vert}_{{\underline{θ}}_{t}} = \frac{1}{M} {\sum }_{i} {\sum }_{j = {ℋ}_{i}} \frac{\partial φ ( {\underline{n}}_{i} , {\underline{n}}_{j} , {y}_{ij} )}{\partial \underline{θ}} \vert}_{{\underline{θ}}_{t}} \qquad ( 15 )$$

by an estimate from a single i,j pair drawn at random at a time t.

$${{Δφ}_{{i}_{t} {j}_{t}} ( {θ}_{t} ) {=}^{Δ} \frac{\partial φ ( {\underline{n}}_{{i}_{t}} , {\underline{n}}_{{j}_{t}} , {y}_{{i}_{t} {j}_{t}} )}{\partial \underline{θ}} \vert}_{{\underline{θ}}_{t}} . \qquad ( 16 )$$

The resulting SGD update rule is

θₜ₊₁=θₜ−γₜ·}φ_{it jt}(θₜ) (17)

where γt is a learning rate that can be made to decay with t, e.g., γt=γ0/(t+t0). SGD is guaranteed to converge to a local minimum for sufficiently small values of γt and here we use constant values (γt=γ∀t) set by cross-validation.

When the power normalization and ι2 normalization post-processing stages represented by equations (6) and (7) are used, the gradient in equation (16) required in equation (17) can be computed using the chain rule as follows, using the notation

$${\frac{\partial \underline{y}}{\partial {\underline{x}}_{i}} = \frac{\partial \underline{y}}{\partial \underline{x}} \vert}_{{\underline{x}}_{i}} \text{:} ∇ {φ}_{i , j} ( θ ) = \frac{\partial φ}{\partial {\underline{n}}_{i}} \cdot \frac{\partial \underline{n}}{\partial {\underline{p}}_{i}} \cdot \frac{\partial \underline{p} ( {I}_{i} )}{\partial \underline{θ}} + \frac{\partial φ}{\partial {\underline{n}}_{j}} \cdot \frac{\partial \underline{n}}{\partial {\underline{p}}_{j}} \cdot \frac{\partial \underline{p} ( {I}_{j} )}{\partial \underline{θ}} , \qquad ( 18 )$$

where θ can contain the αj parameters of the power normalization step or the offset parameters d=[dₖ]k of equation (4). The partial derivatives in the above expression are given below, where k, ι ∈ {i, j}:

$$\begin{matrix}\frac{\partial φ}{\partial {\underline{n}}_{k}} = \{ \begin{matrix}0 , & if {y}_{kl} \cdot ( {\underline{n}}_{k}^{T} \cdot {\underline{n}}_{l} + \underline{b} ) \geq ɛ \\ - {y}_{kl} \cdot {\underline{n}}_{l} , & otherwise\end{matrix} , & ( 19 ) \\ & ( 20 ) \\ \frac{\partial \underline{p}}{\partial \underline{α}} = diag ( {[ log ( \vert {v}_{i} \vert ) \cdot {\vert {v}_{i} \vert}^{{α}_{i}} ]}_{i} ) , & ( 21 ) \\ \frac{\partial \underline{n}}{\partial \underline{p}} = {\vert \underline{p} \vert}_{2}^{- 1} ( {I}_{\underline{\_}} - {\underline{nn}}^{T} ) . & ( 22 )\end{matrix}$$

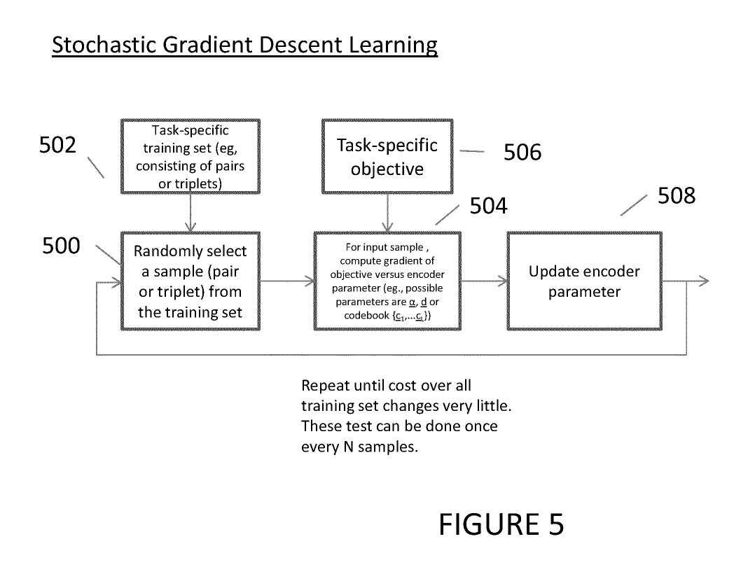

To better appreciate the image retrieval with feature learning technique of the present principles, and especially the application of the Stochastic Gradient Descent (SGD) algorithm, refer to FIG. 5, which depicts in flow chart form the steps of a process that applies SGD to encoding parameters. The process commences with step 500 at which time, samples (e.g., pairs or triplets) are obtained from a task-specific training set 502. Thereafter, for each input sample, the gradient of a specific task objective, as specified in a task-objective file 506, is computed versus an encoder parameter (such as encoder parameters α, or d or code book {c₁,. . . c_{L}}). Thereafter, the encoder parameters are updated. These steps are repeated until the cost over the training set changes very little.

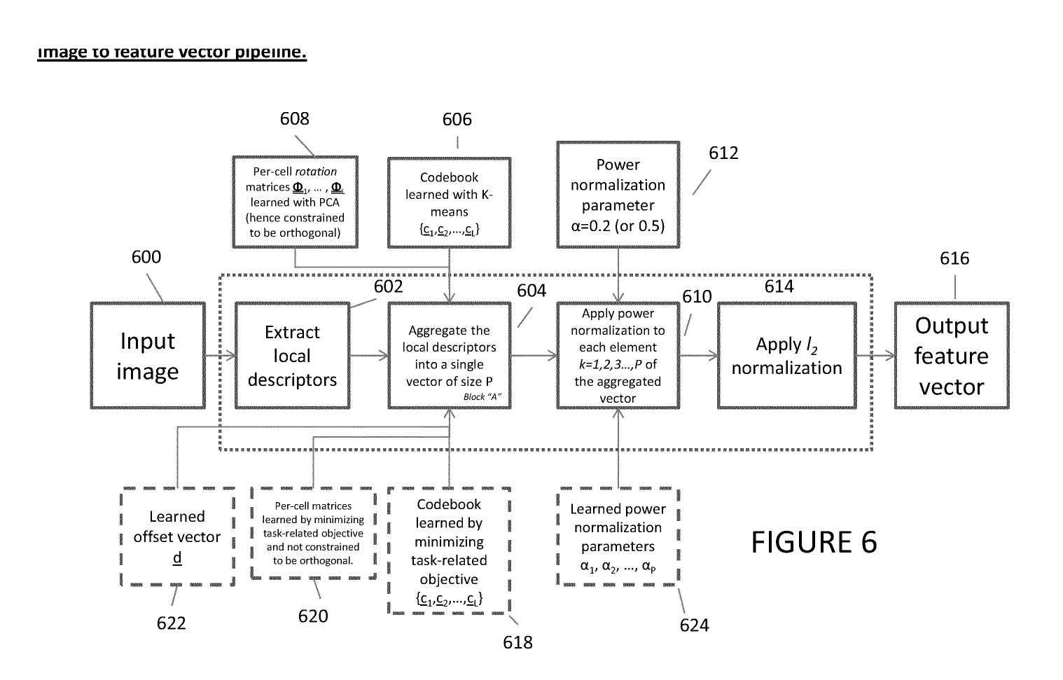

FIG. 6 depicts a full image-to-feature pipeline for the image retrieval with feature learning technique of the present principles. For ease of discussion, the steps in FIG. 6 depicted in solid lines represent elements of traditional image retrieval, whereas the elements depicted in dashed lines depict elements associated with image retrieval with feature learning technique of the present principles. The image retrieval pipeline depicted in FIG. 6 begins with acquisition of image in step 600, either the query image or a set of search images. Thereafter, the input image undergoes encoding, which begins with extraction of the local descriptors of that image during step 602.

Following step 602, the extracted local features are aggregated into a single vector of size P (e.g., the feature vector) during step 604. Traditionally, the aggregation of the features to obtain the feature vector included assigning each descriptor xᵢ to the closest code word cₖ and rotating each sub-vector rk by Φₖ using the input parameters s depicted in steps 606 and 608, respectively. Following aggregation of the local descriptors, power normalization is applied during step 610, typically using power normalization where a=0.2 or 0.5 as indicated in step 612. During step 614 ι₂ normalization is applied, completing the encoding process. Thus, the steps 602-614 collectively comprise the traditional encoding process, following output of the feature vector during step 616.

The image retrieval with feature learning method of the present principles includes several improvements to the traditional encoding process. Rather than use a codebook 606 learned using K-means, the proposed method uses a codebook 618 that was learned by minimizing a task-related objective so as to pick good values for the codebook {cₗ, . . . , c_{L}}.

In addition, rather than simply rotating the vectors as depicted in step 608 for conventional encoding, the image retrieval with feature learning method of the present principles learns Per-cell matrices 620 that are not constrained to be orthogonal by minimizing a task-related objective. In addition, the image retrieval with feature learning method of the present principles also makes use of a learned offset vector d as indicated in step 622. Also, instead of using a fixed value of α as with step 612, the image retrieval with feature learning method of the present principles makes used of learned power normalization parameters α₁, α₂, . . . , α_{P}.

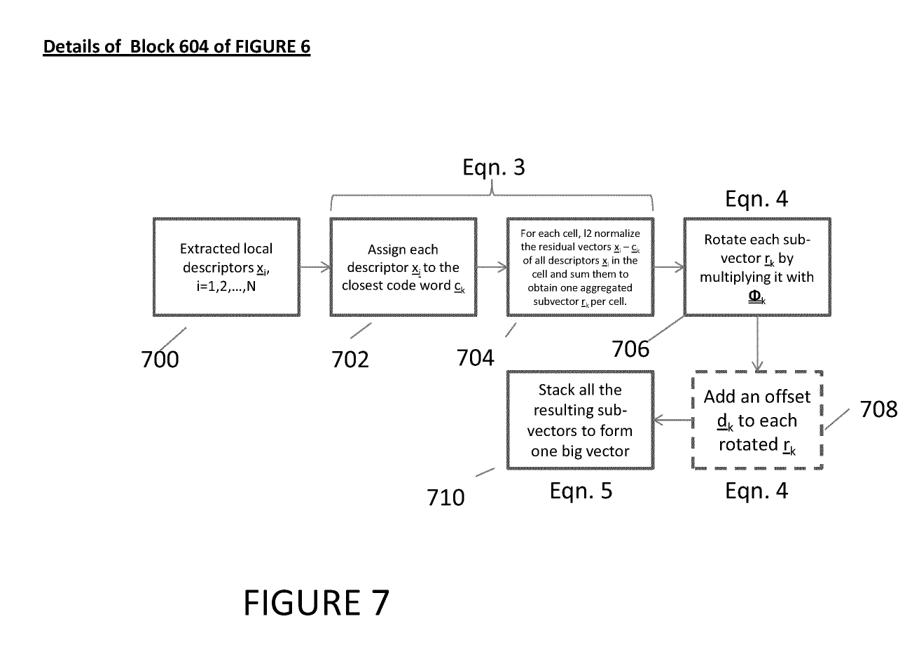

FIG. 7 depicts details of aggregation performed during step 604 of FIG. 6. The aggregation process of FIG. 7 begins with identifying the local descriptors during step 700. Thereafter, each descriptor xᵢ is assigned to the closest code word cₖ during step 702. Thereafter, for each cell, 12, the residual vectors xᵢ-cₖ of all descriptors xᵢ in the cell are normalized and summed to obtain one aggregated sub-vector rₖ per cell during step 704. Note that the actions taken during steps 702 and 704 correspond to equation (3). During step 706, each sub-vector rₖ is rotated by multiplying it Φₖ. An offset dₖ is added to each rotated sub-vector rₖ during step 708. The combination of steps 706 and 708 correspond equation (4). The resulting sub-vectors are stacked to form one big vector during step 710, corresponding to equation (5).

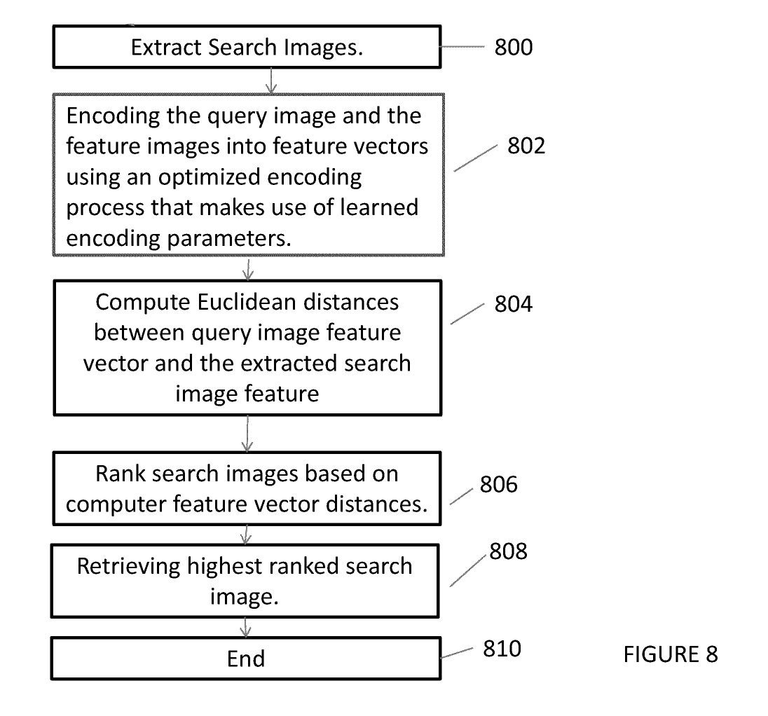

FIG. 8 depicts in flow chart form a method for image retrieval in accordance with the present principles. The method commences with step 800 during which the processor 12 of FIG. 1 extracts a data set of search images from a database, e.g., memory 14 of FIG. 1. The processor 12 then encodes a query image and encodes the search images using one of the encoding techniques described previously (e.g., Bag-of-Words, Fisher or VLAD encoding) during step 802. In advance of image retrieval, the processor 12 optimize its encoding process by making use of a set of training images to learn a set of encoder parameters, for example learned values, such as the alpha parameter and/or the d parameter. Following step 802, the processor 12 compute the distances (e.g., the Euclidean distance) between the query image feature vector and the extracted search image feature vectors during step 804. Thereafter, the processor 12 of FIG. 1 ranks the search images based on the computed distances during step 806 with the closest image being ranked the highest. At least one highest ranked image is retrieved during step 808 Note that during step 808, the processor 12 could retrieve more than one image, for example the 5 or 10 highest ranked images. Thereafter, the process ends at step 810.

Experimental testing of the image retrieval with feature learning technique of the present principles was undertaken using as a data set a collection of images known as INRIA Holidays containing 1491 high-resolution personal photos of various locations and objects divided into 800 groups of matching images. The retrieval performance in all the experimentation was measured by mAP (mean average precision), with the query image not included in the resulting ranked list.

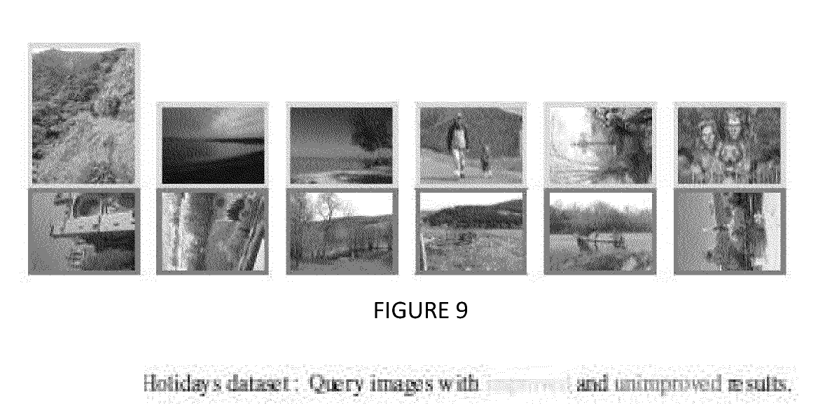

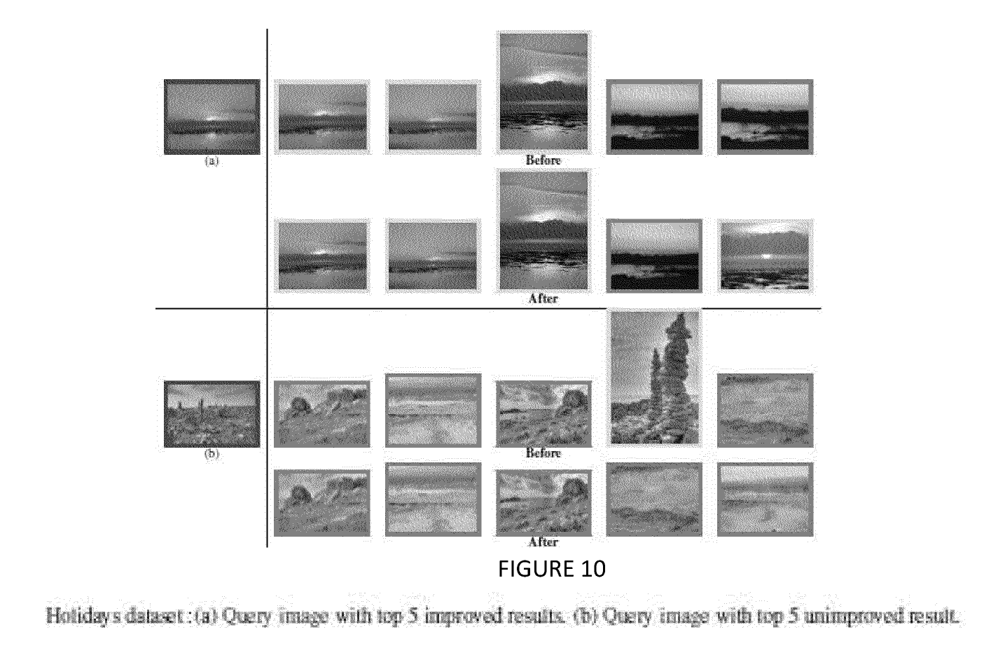

To experimentally learn a, the sample data-set consisted of some 8000 (i, j) image pairs obtained from the INRIA HOLIDAY images composed of positive and negative pairs in equal number. For each image i, pairs (i, j) are built using all positive images belonging to Mi and equal number of high-ranked negative images for same image i. Experimentation was carried out using descriptors extracted using Hessian-affine detector [ ] and Dense detector [ ] separately. The Learning rate parameter γt was kept fixed and equal to 1.0 in both cases. FIGS. 9 and 10 show examples of the query images with improved and unimproved results.

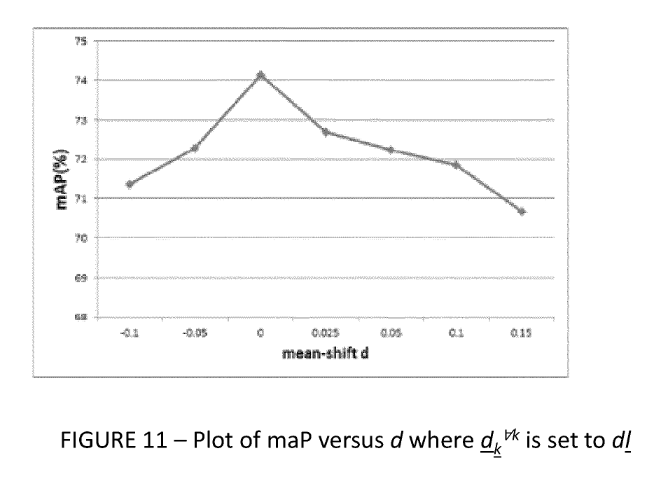

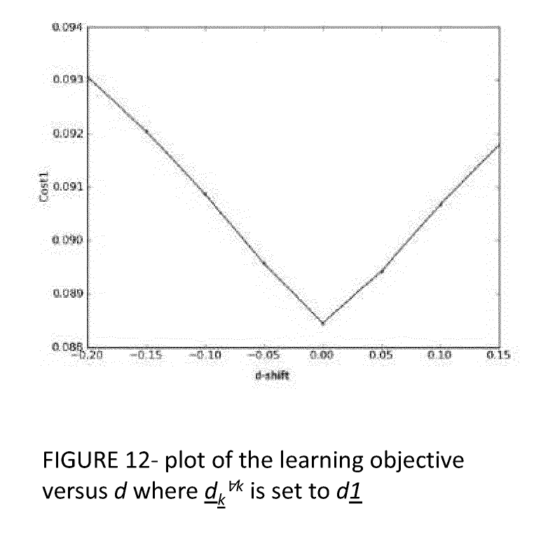

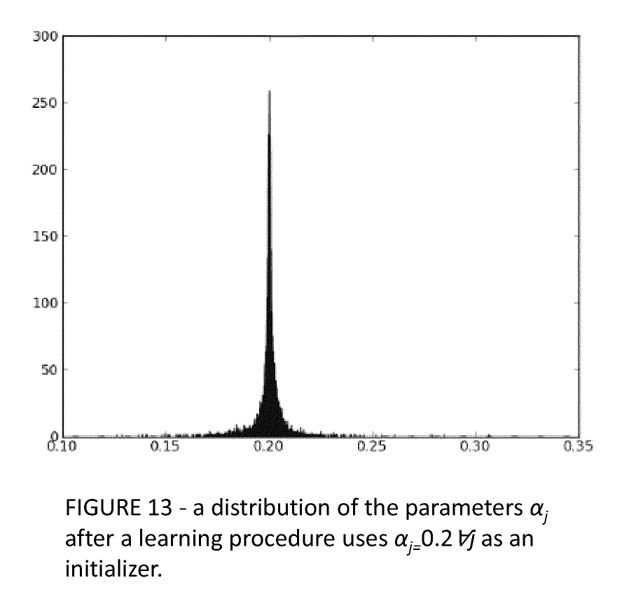

FIG. 11 depicts a plot of mAP versus d, where dk∀k in equation (4) is set to dl. FIG. 12 depicts a plot of the learning objective in equation (12) versus d, where dk∀k in equation (4) is set to dl. The plot of FIG. 12 shares a common optimum at d=0 with the mAP versus d plot in FIG. 11, showing that the learning objective of the present principles is a good surrogate for mAP and hence a good learning objective for image retrieval. FIG. 13 depicts a distribution of parameters αj after learning procedure when using αj=0.2∀j as initializer.

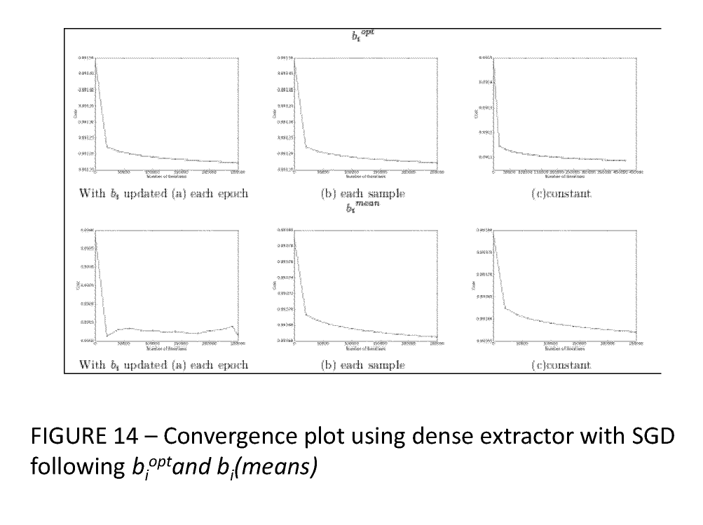

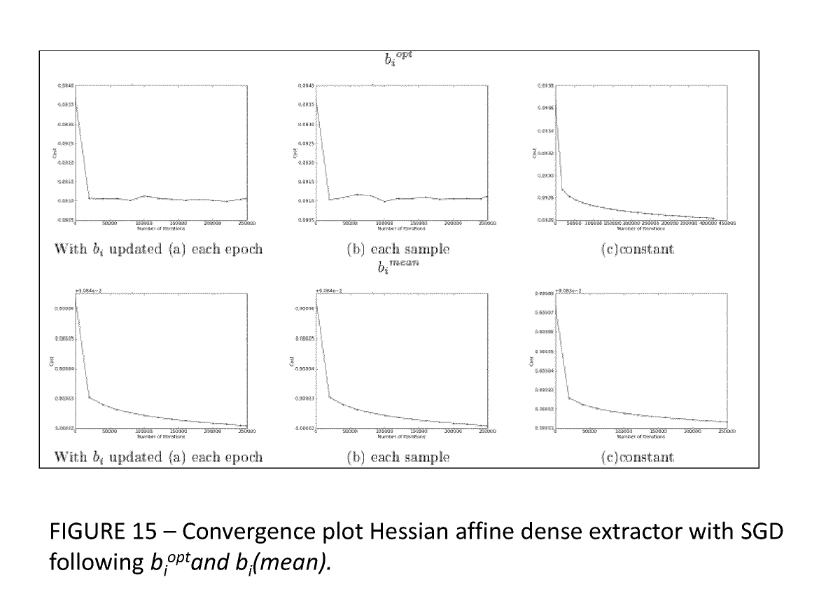

In connection with the experimental testing discussed above convergence plots were generated after 30 passes over the entire image pairs sample as shown in FIGS. 14 and 15 for dense and Hessian affine extractors respectively. The convergence plot of FIG. 14 corresponds to changing the bi's (b^{mean} and b^{opt}) for each epoch and simultaneously updating the positive and negative image pairs. Similarly, in FIG. 15, the individual plots (a) and (b) correspond to the same as in FIG. 14. From these plots, it becomes clear these regular updates make the convergence plots unstable. On the contrary, in FIGS. 14 and 15, it may be useful to changes the bi's, iteratively with each sample. The best results obtained in terms of mAP for both dense and Hessian affine descriptors appear in Table 1 below. The experimentation was done by initializing a to be a constant vector of values 0.2. In case of dense we obtain an improvement of 0.6 in mAP. In the case of Hessian affine there is a slight improvement in the results.

TABLE 1

| | | | mAP at α Learned | | |
|---|---|---|---|---|---|
| Descriptors | α | mAP | bᵢ^{min} | bᵢ^{mean} | bᵢ^{ag} |
| Dense | 0.2 | 72.71 | 72.70 | 73.37 | 72.79 |
| | 0.5 | 65.69 | 66.00 | 66.30 | 66.25 |
| Hessian Affine | 0.2 | 65.69 | 65.70 | 65.80 | 65.75 |
| | 0.5 | 64.10 | 64.15 | 64.30 | 64.25 |

The foregoing works can be extended as follows. The learning objectives described in equations (12) and (14) result in minima that are very sensitive to the method used to select bi. An alternative exists that dispenses of bi and enforces correct ranking but using image triplets. Given an image with label i, correct matches Mi and incorrect matches Ni, the alternate proposed objective is:

$$\begin{matrix}{\sum }_{i , j ∈ {i}_{} , k ∈ {N}_{i}} Ψ ( {\underline{n}}_{i} , {\underline{n}}_{j} , {n}_{k} ) , & ( 23 ) \\ where & \\ Ψ ( \underline{η} , \underline{a} , \underline{b} ) = max ( 0 , ɛ - ( {\underline{η}}^{T} ( \underline{a} - \underline{b} ) ) ) & ( 24 )\end{matrix}$$

and ε enforces some small, non-zero margin that can be held constant (e.g., ε=1e−2) or increased gradually during the optimization (e.g., between 0 and 1e−1).

In this case, the gradient with respect to parameter θ is given by

$${{{∇ {φ}_{i , j , k} ( θ ) {=}^{Δ} \frac{\partial ψ}{\partial \underline{η}} \vert}_{{\underline{n}}_{i}} \cdot \frac{\partial \underline{n}}{\partial {\underline{p}}_{i}} \cdot \frac{\partial \underline{p} ( {I}_{i} )}{\partial \underline{θ}} + \frac{\partial ψ}{\partial \underline{a}} \vert}_{{\underline{n}}_{j}} \cdot \frac{\partial \underline{n}}{\partial {\underline{p}}_{j}} \cdot \frac{\partial \underline{p} ( {I}_{j} )}{\partial \underline{θ}} + \frac{\partial ψ}{\partial \underline{b}} \vert}_{{\underline{n}}_{k}} \cdot \frac{\partial \underline{n}}{\partial {\underline{p}}_{k}} \cdot \frac{\partial \underline{p} ( {I}_{k} )}{\partial \underline{θ}} . \qquad ( 25 )$$

SGD update rule for this case operates at each time instant t, on a triplet Iᵢ_{ₜ}, Iⱼ_{ₜ}, Iₖ_{ₜ}, where jₜ ∈ [symbol] ᵢ_{ₜ} and k ∈ [symbol] ₖ_{ₜ}:

θₜ₊₁=θₜ−γₜ·∇φᵢ_{ₜ}ⱼ_{ₜ}ₖ_{ₜ}(θₜ) (26)

The binarization thresholds d=[dₖ]k in (4) can also be learned using gradients computed via equations (18) or (25) with θ=d. The required Jacobian is

$$\begin{matrix}\frac{\partial \underline{p}}{\partial \underline{d}} = \frac{\partial \underline{p}}{\partial \underline{q}} \cdot \frac{\partial \underline{q}}{\partial \underline{d}} & ( 27 ) \\ = diag ( {[ {\vert {q}_{i} \vert}^{α - 1} ]}_{i} ) \cdot {I}_{\underline{\_}} & ( 28 )\end{matrix}$$

Numerical issues due to powers of α−1: The entries |qi|^{α-1} in equation (28) can pose numerical problems when the qi are close to zero. One way to avoid this is to keep the corresponding entry for di fixed during the update step. This amounts to removing the i-th entry of ∇φi, j,k(θ) in equation (25), updating only dj for j ±i

The learning objectives proposed herein allows us to learn feature encoders that are robust to specific transformations in a structured manner. As discussed in the introduction, image retrieval applications are defined by a transformation that is inherent to the specific task.

A few examples of relevant applications include:
1. Matching a keyframe to the closest frame from a sparse temporal sampling of video frames—this has applications in video bookmarking, or to create image-feature-based pointers to video time instances (timestamp based pointers are vulnerable to editing).
2. Matching pictures of video screens to keyframe databases—this can enable applications to recognize, for example, the TV program being displayed.
3. Image retrieval that is robust to image editing—this can enable an artist to retrieve the original artwork, and all its derivations.

Although not discussed in detail, the proposed image retrieval objective can also be used to learn the code book {cₖ} k or the rotation matrices Φ in equation (4)

The foregoing describes a technique for image retrieval using a learning objective.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method for retrieving at least one search image matching a query image, comprising:
extracting a set of search images;
encoding the query image into a query image feature vector and encoding the search images into search image feature vectors using an optimized encoding process that makes use of learned encoding parameters;
computing distances between the query image feature vector and the search image feature vectors
ranking the search images based on the computed Euclidean distances; and
retrieving at least one highest rated search image.

2. The method according to claim 1 wherein the encoding process is optimized by using a gradient-based optimization over images of training set to minimize a learning objective over the training set and learn feature vector parameters.

3. The method according to claim 1 wherein the encoding process includes aggregating local descriptors of an image into a single large feature vector based on a model for the distribution of the local descriptors.

4. The method according to claim 1 wherein the encoding process includes one of VLAD encoding, Bag-of-Words encoding or a Fisher encoding process.

5. The method according to claim 4 wherein the encoding process includes extracting local descriptors using a Hessian-affine detector.

6. The method according to claim 4 wherein the encoding process includes extracting local descriptors using a dense detector.

7. The method according to claim 1 wherein the learned encoding parameters include at least one of encoding power normalization parameters α₁, α₂, . . . , α_{P} where P is the feature vector size), and offset values or code book values {c₁, . . . c_{L}}.

8. The method according to claim 1 wherein the encoding process includes the steps of:
extracting local descriptors;
assigning code words to the local descriptors;
normalizing residual vectors obtained by assigning code words and summing the residual vectors to obtained one aggregated sub-vector per cell;
rotating each sub-vector;
adding an offset vector to each rotated sub-vector; and
stacking the resulting sub-vectors to yield a feature vector.

9. A computer program product, characterized in that it comprises instructions of program code for executing steps of the method according to one of claim 8, when said program is executed on a computer.

10. A processor readable medium having stored therein instructions for causing a processor to perform at least the steps of the method according to one of the claim 8.

11. An image retrieval system for retrieving at least one search image matching a query image, comprising:
a memory (14) for storing a set of search images; and
a processor (12) configured to (a) extract a set of search images; (b) encode the query image into a query image feature vector and encoding the search images into search image feature vectors using an optimized encoding process that makes use of learned encoding parameters (c) compute distances between the query image feature vector and the search image feature vectors; (d) rank the search images based on the computed distances; and (e) retrieve at least one highest rated search image.

12. The image retrieval system according to claim 11 wherein the processor optimizes the encoding process in advance of encoding the query image and the search images using a gradient-based optimization over images of a training set to minimize a learning objective over the training set and learn feature vector parameters.

13. The image retrieval system according to claim 11 wherein processor performs encoding by aggregating local descriptors of an image into a single large feature vector based on a model for the distribution of the local descriptors.

14. The image retrieval system according to claim 11 wherein the processor encodes the query image and the search images using one of VLAD encoding, Bag-of-Words encoding or Fisher encoding.

15. The image retrieval system according to claim 11 wherein the processor uses a Hessian-affine detector to extract image features during encoding.

16. The image retrieval system according to claim 11 wherein the uses a Dense detector to extract images during encoding.

17. The image retrieval system of claim 11 wherein the learned encoding parameters include at least one of encoding power normalization parameters α₁, α₂, . . . , α_{P} where P is the feature vector size), and offset values or code book values {c₁, . . . c_{L}}.

18. The image retrieval system of claim 10 wherein the processor performs the encoding process by (a)extracting local descriptors from the images; (b) assigning code words to the local descriptors; (c) normalizing residual vectors obtained by assigning code words and summing the residual vectors to obtain one aggregated sub-vector per cell; (d) rotating each sub-vector; (e) adding an offset to each rotated sub-vector; (f) stacking the resulting sub-vectors to yield a feature vector.
